(19) United States
(12) Patent Application Publication
(10) Pub. No.: US 2007/0026251 A1
(43) Pub. Date: Feb. 1, 2007

(54) Flexible packaging laminate films including a block copolymer layer

(75) Inventor: Mario G. Umana, Houston, TX (US)

Correspondence Address: KRATON POLYMERS U.S. LLC, WESTHOLLOW TECHNOLOGY CENTER, 3333 HIGHWAY 6 SOUTH, HOUSTON, TX, 77082, US

(73) Assignee: KRATON Polymers U.S. LLC, Houston, TX (US)

(21) Appl. No.: 11/408,497

(22) Filed: Apr. 21, 2006

Related U.S. Application Data
(60) Provisional application No. 60/702,506, filed on Jul. 26, 2005.

(51) Int. Cl. B32B 27/32; B32B 27/08

(52) U.S. Cl. 428/517; 428/523; 428/521

(57) ABSTRACT

A flexible packaging laminate film having improved interlayer adhesion and toughness without compromising other physical properties which is a laminate of at least one film layer of a polyolefin and at least one film layer of a block copolymer. The block copolymer employed in the present invention includes an unhydrogenated block copolymer having a monoalkenyl arene content equal to or greater than 60 weight percent and a modulus less than about 100,000 psi.

This application claims the benefit of U.S. Provisional Patent Application No. 60/702,506, filed Jul. 26, 2006.

### FIELD OF THE INVENTION

The present invention is directed to flexible packaging laminate films having improved interlayer adhesion between the laminations that include at least one block copolymer layer and at least one polyolefin layer. More specifically, the present invention is directed to multilayered flexible packaging laminate films having improved interlayer adhesion in which the block copolymer layer comprises an unsaturated high monoalkenyl arene content block copolymer having a modulus less than about 100,000 psi. The present invention is also directed to hygienic and non-hygienic articles that include the flexible packaging laminate films of the present invention.

### BACKGROUND OF THE PRIOR ART

Flexible packaging film is produced in great volume to meet extensive demand in a variety of industrial applications in which such films are utilized. The hallmarks of good flexible multilayer packaging film are superior interlayer adhesion, toughness, optical, and safety properties and low cost at the lowest possible gauge. To date, no single class of packaging film is optimum in all of these categories. For example, although flexible polyvinyl chloride (PVC) can be fabricated into a tough, clear and low cost packaging film product, the safety aspect of flexible PVC film, especially in the packaging of edible material, is suspect. There is thus a long felt need in the art for a packaging film, free of vinyl chloride, which provides the advantages associated with flexible PVC film.

Polyolefin film is environmentally safe. In addition, various polyolefinic films are quite clear and relatively inexpensive. However, the problem associated with the use of polyolefin films, which are highly attractive from the point of view of environmental safety, is their low degree of toughness compared to flexible PVC film. For example, one of the strongest of the polyolefinic films is polypropylene (PP) film. Still, the toughness characteristics of PP film, as measured by dart impact or puncture resistance, are significantly below the corresponding values of less environmentally safe flexible PVC film.

It is well known in the art to laminate layers in order to increase toughness of thin films. However, this expedient does not overcome the inherent low strength characteristics of polyolefins. This is due to one or more of the following deficiencies of multilayer polyolefin films: failure due to delamination, excessive thickness and loss of optical properties. For example, when laminated films are utilized to make packages that are heat sealed, one of the problems often encountered is that when an attempt is made to pull the package open, the film begins to delaminate (peel off in layers rather than allowing separation as if the film is one layer at the point of heat sealing). These defects emphasize that laminate films of polyolefin are unsuitable replacements for flexible PVC high strength films.

This is not to say that there have been no recent developments in lamination of environmentally safe polyolefin films to increase toughness. A study of the adhesive strength of polyolefin laminate film bonding is reported by Ronesi et al., in J. App. Poly. Sci., 89, 153-162 (2003). That study established that when ethylene-styrene copolymer (ES) films were bonded to low-density polyethylene (LDPE) films, delamination toughness, determined in a T-peel test, although impressive, exposed certain problems associated with the use of ES copolymers. As set forth in FIG. 4 of that disclosure, adhesion to LDPE, a typical polyolefin, decreased with increasing concentration of styrene. Indeed, extrapolation of the curve indicated that when the styrene concentration reaches 72.5% by weight, based on the total weight ES copolymer, styrene would have no adhesion to LDPE.

That the Ronesi et al. paper attempts to develop new laminate forms to increase film toughness is indicative of the need in the art to enhance polyolefin film toughness.

The above remarks emphasize the strong need in the art for a new class of compatible polymers that can be bonded to polyolefin films to increase the toughness of the films without adversely affecting the desirable thickness, cost and optical properties of polyolefin packaging film, and allowing the design of a structure that meets desired, among others, permeation requirements.

### SUMMARY OF THE INVENTION

The present invention provides a flexible packaging laminate film that imparts improved interlayer adhesion, clarity and toughness to a polyolefin film without adversely affecting those polyolefin characteristics which prompt its utilization as a flexible packaging film. That is, a flexible packaging laminate film is provided which embodies the desirable physical properties of polyolefin films, including environmental safety, optical and thickness, but significantly increases the toughness characteristics of the polyolefin bonded flexible packaging laminate film; by utilizing at least one unsaturated block copolymer layer with one or more polyolefin layers.

In broad terms, the present invention provides a flexible packaging laminate film having improved interlayer adhesion that comprises at least one polyolefin layer and at least one unsaturated block copolymer layer. In one embodiment of the present invention, at least one of the outer layers is an unsaturated block copolymer layer. In a second embodiment of the present invention, each of the outer layers of the film is a polyolefin layer (the unsaturated block copolymer layer(s) are sandwiched between polyolefin layers; the unsaturated block copolymer layer(s) are tie layers between the polyolefin layers that function to tie together the polyolefin layers. In each embodiment the unsaturated block copolymer layer comprises a block copolymer that has a high monoalkenyl arene content and a modulus less than 100,000 psi. The block copolymers employed in the present invention will be described in greater detail hereinbelow.

In one embodiment of the present invention, a flexible packaging film is provided which is a laminate of at least one layer of a polyolefin homopolymer or copolymer and at least one layer of an unsaturated high monoalkenyl arene content block copolymer having a modulus less than 100,000 psi wherein in said film, at least one of the outer layers is an unsaturated block copolymer layer. The laminate of this embodiment may have any number of layers provided that at least one of the outer layers is an unsaturated block copolymer layer. Preferably the laminate is a two to ten-layered ply in which one outer layer is an unsaturated block copolymer.

In still another embodiment of the present invention, a flexible packaging film is provided which is a laminate of at least two layers of a polyolefin homopolymer or copolymer tied together with at least one layer of an unsaturated high monoalkenyl arene content block copolymer having a modulus less than 100,000 psi wherein each of the outer layers is a polyolefin layer. The laminate of this embodiment may have any number of layers provided that the outer layers are polyolefin layers. Preferably, the laminate is a three, five, seven or nine-layered ply including individual or multiple unsaturated block copolymer layers sandwiched between polyolefin layers, more preferably a three-layered ply including the unsaturated block copolymer sandwiched between two polyolefin layers.

The block copolymers of the present invention are unsaturated block copolymers having a monoalkenyl arene content equal to or greater than about 60 weight percent based on the total weight of the block copolymer and a modulus less than about 100,000 psi. These block copolymers include at least two A blocks and at least one B block, wherein each A block is a mono alkenyl arene homopolymer block and each B block is selected from (a) a polymer block of at least one conjugated diene and at least one mono alkenyl arene and having a random distribution, (b) a polymer block of at least one conjugated diene and at least one mono alkenyl arene and having a blocked distribution; (c) a polymer block of at least one conjugated diene and at least one mono alkenyl arene and having a tapered distribution; and (d) a polymer block of at least one conjugated diene and at least one mono alkenyl arene and having a controlled distribution.

The present invention also embraces hygienic and non-hygienic articles that include or are made from the flexible packaging laminate films of the present invention. The non-hygienic articles can be used, for example, in food, medical, industrial or houseware applications.

### DETAILED DESCRIPTION OF THE INVENTION

As stated above, the present invention provides a flexible packaging laminate film that includes at least one polyolefin layer and at least one block copolymer layer, said block copolymer layer comprising an unsaturated block copolymer having a high monoalkenyl arene content and a modulus less than about 100,000 psi. The flexible packaging films of the present invention exhibit desirable properties of polyolefin films, such as environmental safety, optical, thickness, affinity to polyolefins and thermal (sealing) while exhibiting a significant improvement in interlayer adhesion, and imparting toughness which has not been observed from prior art polyolefin films that do not include the block copolymer component.

As used within the entire text of this specification, the terms “optical”, “optical properties” and “optical qualities” refer to clarity as measured by haze and light transmittance using standard tests which are known in the art.

In addition, as used herein, the terms “interlayer adhesion” or “interlayer adhesion properties” refer to the ability of the layers in the laminate of the present invention to adhere to one another when subjected to stress-to the ability of the block copolymer layers of the present invention to adhere to the polyolefin layers of the present invention such that the layers to not peel apart (delaminate) when subjected to various types of stress.

Also, as used herein, the terms “tie”, “tying” and “tie layer” each refer to the ability of the block copolymer layers of the present invention to bond, secure or anchor the polyolefin film layers of the laminate together without adversely influencing impact and strength properties (e.g., in the situations where the block copolymer layer is sandwiched between polyolefin layers.

Flexible packaging films within the contemplation of the present invention include those that employ environmentally safe polymers of the prior art. A principal class of such polymers is polyolefins. The polyolefins within the scope of the present invention are those known to be useful in the manufacture of films, as well as those less frequently employed in the manufacture of flexible packaging laminate films, and include both linear and branched polyolefins. Among the non-limiting class of polyolefins which are included within the present invention to produce flexible packaging laminate films include ethylene-, propylene- and butylene-based olefins. Exemplary polymers include, for example, ethylene homopolymers, ethylene/alpha-olefin copolymers, propylene homopolymers and copolymers, propylene/alpha-olefin copolymers, high impact polypropylene, butylene homopolymers, butylene/alpha olefin copolymers and other alpha olefin copolymer or interpolymers. Representative polyolefins include, for example, but are not limited to, substantially linear ethylene polymers, homogeneously branched linear ethylene polymers, heterogeneously branched linear ethylene polymers, including, but not limited to, linear low density polyethylenes (LLDPE), ultra or very low density polyethylenes (ULDPE or VLDPE), medium density polyethylenes (MDPE), high density polyethylenes (HDPE) and high pressure low density polyethylenes (LDPE). Other polymers included hereunder are ethylene/acrylic acid (EAA) copolymers, ethylene/methacrylic acid (EMAA) ionomers, ethylene/vinyl acetate (EVA) copolymers, ethylene/vinyl alcohol (EVOH) copolymers, ethylene/cyclic olefin copolymers, propylene homopolymers and copolymers, propylene/styrene copolymers, ethylene/propylene copolymers, polybutylene, ethylene carbon monoxide interpolymers (for example, ethylene/carbon monoxide (ECO) copolymer, ethylene/acrylic acid/carbon monoxide terpolymer and the like). Preferred are high clarity, soft olefin polymers such as polyethylene an polypropylene copolymers, plastomers, elastomers and interpolymers. In addition, the polyolefins of the present invention can be polyolefins made using any of the metallocene catalyst technology available. Examples of commercially available polyolefins which may be used in the present invention include, but are not limited to, Marflex® 5355, a low density polyethylene polymer commercially available from Chevron Phillips, Marflex® 7109M, a linear, low density polyethylene polymer commercially available from Chevron Phillips, LDPE 1010®, a low density polyethylene polymer commercially available from Huntsman Polymers, and PE 5050®), a low density polyethylene polymer commercially available from Huntsman Polymers; LLDPE 8101®, a linear low density polyethylene polymer commercially available from Huntsman Polymers; and PP 12N25A®, a commercially available polypropylene polymer commercially available from Huntsman Polymers, PP 12G25A®, a polypropylene polymer commercially available from Huntsman Polymers, and Sunoco FT021N, a homopolymer polypropylene commercially available from Sunco. While the multilayer films of the present invention are contemplated to comprise polyolefin layers that could comprise any of the above polyolefins, the preferred polyolefins are polypropylene and polyethylene. Also contemplated within the scope of the present invention are multilayer films in which the polyolefin layers are formed from different polyolefins (e.g., a three layered film that comprises a first layer of one polyolefin and a second layer of a different polyolefin with a layer of styrenic block copolymer sandwiched between said first and second polyolefin layers; more specifically as an example, a first layer of polypropylene and a second layer of polyethylene with a layer of block copolymer sandwiched between said first and second polyolefin layers or a three layered film that comprises a fist layer of one polyolefin, a second layer of a different polyolefin and a third layer of block copolymer multilayer wherein the third layer is one of the outer layers; more specifically as an example, a first layer of polypropylene, a second layer of polyethylene and a third layer of block copolymer).

In addition to the polyolefin layer(s), the flexible packaging laminate films of the present invention also include at least one unhydrogenated block copolymer layer. The block copolymers used in the laminate of the present invention are well known for their toughness and include what has traditionally been referred to one or more rubber blocks and one or more glassy blocks. However, block copolymers of the type described herein have not often been used in the production of flexible packaging films due to the problems often associated with films made from such block copolymers. Although the invention is independent of any theory explaining its operation, the reason why many block copolymers have not commonly been employed in flexible packaging films is believed to be their incompatibility with polymers, such as polyolefins, that are usually employed in this application. The present invention is predicated upon the identification of a specific class of block copolymers that have been found to be highly compatible with polyolefins utilized in flexible packaging films. Indeed, the block copolymers of the present invention are particularly suitable for bonding to polyolefin layers in a multilayer structure of the type employed in the manufacture of flexible packaging film. Thus, the present invention contemplates laminated films having any number of layers.

As stated above, the flexible packaging films of the present invention include at least one polyolefin layer and at least one block copolymer layer wherein the block copolymers are selected from unsaturated block copolymers having a high monoalkenyl arene content and a modulus less than about 100,000 psi.

The block copolymers utilized in the present invention broadly comprise any unsaturated block copolymers that meet the following criteria:

(1) the block copolymer has a monoalkenyl arene content equal to or greater than 60 weight percent, based on the total weight of the block copolymer;

(2) the block copolymer has a modulus less than about 100,000 psi; and

(3) the block copolymer has at least two A blocks and at least one B block
wherein each A block is a monoalkenyl arene polymer block and
wherein each B block is selected from:
   (a) polymer blocks having at least one conjugated diene and at least one mono alkenyl arene and having a random distribution;
   (b) polymer blocks having at least one conjugated diene and at least one mono alkenyl arene and having a blocked distribution;
   (c) polymer blocks having at least one conjugated diene and at least one mono alkenyl arene and having a tapered distribution; and
   (d) polymer blocks having at least one conjugated diene and at least one mono alkenyl arene and having a controlled distribution.

One important aspect of the block copolymers used in preparing the films of the present invention is the monoalkenyl arene content. As noted hereinbefore, the monoalkenyl arene content should be equal to or greater than 60 weight percent, based on the total weight of the block copolymer. Typically the monoalkenyl arene content will range from about 60 to about 85 weight percent for the block copolymer. In alternative embodiments, the monoalkenyl arene content will range from about 70 to about 80 weight percent, preferably from about 73 to about 78 weight percent.

Another important aspect of the block copolymers utilized in the present invention is the modulus of the block copolymer. As used herein, the term “modulus” refers to flexural modulus according to ASTM D-790. This modulus refers to the ratio of stress to strain for a given polymer. The block copolymers used in the present invention will have a modulus of less than about 100,000 psi. The modulus is typically less than about 90,000 psi, preferably less than about 80,000 and in some embodiments may even be less than 75,000. Regarding a lower limit, the modulus will typically not be less than about 40,000 psi, preferably not less than about 50,000 psi.

The block copolymers utilized in the films of the present invention have a low melt index allowing for easier processing than similar block copolymers that have higher melt indexes. For purposes of the block copolymers utilized in the present invention, the term “melt index” is a measure of the melt flow of the polymer according to ASTM D1238 at 200° C. and 5 kg weight. It is expressed in units of grams of polymer passing through a melt rheometer orifice in 10 minutes. Broadly, the unhydrogenated block copolymers of the present invention have a melt index from about 1 to about 40 grams/10 minutes. Preferably, the melt index will range from about 3 to about 30 grams/10 minutes, more preferably from about 5 to about 20 grams/10 minutes.

The monoalkenyl arenes utilized in the A and B blocks of the block copolymers may be the same or different and are independently selected from styrene, alpha-methylstyrene, para-methylstyrene, vinyl toluene, vinylnaphthalene, and para-butyl styrene or mixtures thereof. Of these, styrene is the most preferred.

The conjugated dienes of the block B blocks are independently selected from 1,3-butadiene and substituted butadienes, such as, for example, isoprene, piperylene, 2,3-dimethyl-1,3-butadiene, and 1-phenyl-1,3-butadiene, or mixtures thereof. Of these, isoprene and 1,3-butadiene are the most preferred with 1,3-butadine being the more preferred of the two.

While a wide range of molecular weights of the block copolymers utilized in the films of the present invention can be used, in many instances the number average molecular weight of each A block will independently range from about 5,000 to about 200,000, preferably from about 7,500 to about 150,000, and the number average molecular weight of each B block will independently range from about 10,000 to about 100,000, preferably from about 10,000 to about 75,000, for the sequential block copolymers and from about 5,000 to about 50,000, preferable from about 5,000 to about 37,500, for the coupled block copolymers.

As noted above, the B block(s) of the block copolymers that can be utilized in the present invention are selected from a variety of midblocks. More specifically, within the scope of the contemplated block copolymers are those block copolymers wherein the midblocks are considered to have a distribution configuration that is “random”, “blocked”, “tapered” or “controlled”.

More specifically, in embodiment (a) of the present invention, B comprises a polymer block of at least one conjugated diene and at least one monoalkenyl arene wherein the B block has a random distribution. As used herein with regard to the present invention, the phrase “random distribution” means that the distribution of monomers from one end of the block to the other end is roughly uniform (e.g., it is a statistical distribution based on the relative concentrations of the monomers). Preferably, in this embodiment, the conjugated diene of each B block is independently selected from isoprene and butadiene, with butadiene being the most preferred, and the monoalkenyl arene is as defined hereinbefore with regard to A, with styrene be the most preferred.

In the second embodiment (b), B comprises a polymer block comprising at least one conjugated diene and at least one mono alkenyl arene, wherein the B block has a blocked distribution. As used herein with regard to the present invention, the phrase “blocked distribution” means that the distribution is a nonuniform distribution in which the A monomers (or in the alternative the B monomers) are more likely to be grouped with other A monomers (or in the case of the B monomers, with other B monomers) than is found in a statistical (i.e., “random”) distribution thereby resulting in a short “defined” monomer block. Preferably, in this embodiment, the conjugated diene of each B block is also independently selected from isoprene and butadiene with butadiene being the most preferred and the monoalkenyl arene is as defined hereinbefore with regard to A, with styrene being the most preferred.

In the third embodiment (c), B comprises a polymer block comprising at least one conjugated diene and at least one mono alkenyl arene, wherein the B block has a tapered distribution. As used herein with regard to the present invention, the phrase “tapered distribution” means that the distribution is a nonuniform distribution in which the concentration of A monomer (or in the alternative, B monomer) at one end of the block is greater than at the other end of the block (it gradually declines from one end of the block to the other end of the block). As in the other embodiments, preferably the conjugated diene of each B block is also independently selected from isoprene and butadiene with butadiene being the most preferred and the monoalkenyl arene is as defined hereinbefore with regard to A, with styrene being the most preferred.

In the fourth and final embodiment (d), B comprises a polymer block comprising at least one conjugated diene and at least one mono alkenyl arene, wherein the B block has a controlled distribution. For purposes herein with regard to the present invention, the phrase “controlled distribution” is as defined in co-pending and commonly assigned U.S. patent application Ser. No. 10/359,981, filed Feb. 6, 2003 and entitled “NOVEL BLOCK COPOLYMERS AND METHOD FOR MAKING SAME”. The entire contents of the 10/359,981 patent application, are thus incorporated herein by reference. More specifically, the molecular structure of the controlled distribution block copolymer has the following attributes: (1) terminal regions adjacent to the mono alkenyl arene homopolymer (“A”) blocks that are rich in (i.e., having a greater than average amount of) conjugated diene units; (2) one or more regions not adjacent to the A blocks that are rich in (i.e., having a greater than average amount of) mono alkenyl arene units; and (3) an overall structure having relatively low mono alkenyl arene, e.g., styrene, blockiness. For the purposes hereof, “rich in” is defined as greater than the average amount, preferably 5% greater than the average amount. As in the other embodiments, preferably the conjugated diene of each B block is also independently selected from isoprene and butadiene with butadiene being the most preferred and the monoalkenyl arene is as defined hereinbefore with regard to A, with styrene being the most preferred.

The block copolymers of the present invention may be prepared by any of the methods known in the art, including sequential polymerization and coupling using standard coupling agents. Examples of block copolymers that may be used in the films of the present invention, as well as the methods of preparing such block copolymers, include but are not limited to, polymers and methods disclosed in U.S. Pat. Nos. 4,925,899, 6,521,712, 6,420,486, 3,369,160, 6,265,485, 6,197,889, 6,096,828, 5,705,569, 6,031,053, 5,910,546, 5,545,690, 5,436,298, 4,248,981, 4,167,545, 4,122,134, 6,593,430, and U.S. patent application Ser. No. 10/359,981, each incorporated herein by reference.

As noted hereinbefore, the block copolymers used in the present invention have at least two A blocks and at least one B block. Accordingly, the block copolymers used in the present invention may comprise any block copolymer which meets the criteria for the present invention, including block copolymers that are linear sequential, as well as block copolymers that are coupled [including linear coupled (having two arms or branches) and branched coupled (having greater than two arms or branches) block copolymers]. When the block copolymer is linear coupled or branched coupled, the arms may be symmetrical or asymmetrical. Note that when the block copolymer are prepared by coupling, small amounts of diblock copolymer may be present depending upon the coupling agent and the coupling efficiency. Preferably when the block copolymer are prepared by coupling, the amount of diblock present will be less than about 10%, preferably less than about 8%.

While not wishing to be bound by the structure of the present block copolymers, representative structures which contain at least two A blocks and at least one B block and which are considered to be within the scope of the present invention, provided they meet the other criteria noted above, include, but are not limited to block copolymers of the structure:
(1) (A-A₁-B-C)m-X-(C-B-A₁)n or (A-B-C)n-X wherein each A block is independently a polymer block of monoalkenyl arene, each B block is independently a copolymer block of monoalkenyl arene and conjugated diene, each C block is independently a block of conjugated diene and m≦n and m+n is 3 to 20. A blocks of the same block copolymer may have different molecular weights.
(2) A₁-B₁-B₂-A₂, wherein each A₁ block and A₂ block is independently a polymer block of monoalkenyl arene and the each B, block and B's block is independently a polymer block of monoalkenyl arene and conjugated diene.
(3) A-B-A, (A-B)ₙ, (A-B)ₙ-A, (A-B-A)n-X, or (A-B)n-X, wherein each A block is independently a polymer block of monoalkenyl arene, each B block is independently a polymer block of monoalkenyl arene and conjugated diene, X is the residue of a coupling agent and n is from 2 to 30.
(4) A-A₁-B-B₁-X-B₁-B-A₁-A, A-B-B₁-X-B-A, A-A₁-B-B₁-X-B₁-B-A, wherein each A block and A₁ block is independently a polymer block of monoalkenyl arene and each B block and B₁ block is independently a polymer block of monoalkenyl arene and conjugated diene
(5) B-(A-B)n; X-[(A-B)n]m+1; X-[(B-A)n]m+1; X-[(A-B)n-A]m+1; X-[(B-A)n-B)]m+1; Y-[(A-B)n]m+1; Y-[(B-A)n]m+1; Y-[(A-B)n-A]m+1; Y-[(B-A)n-B]m+1 wherein each A block is independently a polymer block of monoalkenyl arene, each B block is independently a polymer block of monoalkenyl arene and diene, X is a radical of an n-functional initiator, Y is a radical of an m-functional coupling agent and m and n are natural numbers from 1 to 10.
(6) (A₁-A₂-B₁-B₂-B₃)ₙ-X-(B₃-B₂-B₁-A2)ₘ, wherein each A₁ block and A₂ block is independently a polymer block of monoalkenyl arene, each B₁ block, B₂ block and B₃ block is independently a polymer block of monoalkenyl arene and conjugated diene and n and m are each independently 0 or ≧3.
(7) A-A₁-B-X-B-A₁-A, A-B-X-B-A, A-A₁-B-X-B-A wherein each A block is independently a polymer block of monoalkenyl arene and each B block is independently a polymer block of monoalkenyl arene and conjugated diene.
(8) A₁-B₁-C₁, A₁-C₁-B₁, A₁-B₁-C₁-A₂ A₁-B₁-C₁-B₂-A₂, A₁-C₁-B₁-C₂-A₂, A₁-B ₁-B₂-C₁-A₂, A₁-B₁-C₁-B₂-C₂-B₃-A₂, A₁-B₁-A₂-B₂-C₁-A₃, A₁-B₁-C₁-A₂-C₂-B₂-A₃, A₁-B₁-A₂-C₁-B₂, A₁-B₁-A₂-B₂-C₁, wherein each A₁ block, A₂ blockand A₃ block is independently a monoalkenyl arene, each B₁, and B₂ is independently a polymer block of monoalkenyl arene and conjugated diene and each C₁ and C₂ is independently a polymer block of conjugated diene.

As used herein, in those instances where it is noted that the blocks are “independently” a polymer block, such polymer blocks can be the same, or they can be different.

Also contemplated within the scope of the present invention are various types of block copolymers that are grafted or functionalized with various functional groups such as unsaturated monomers having one or more functional groups or their derivatives, such as carboxylic acid groups and their salts, anhydrides, esters, imide groups, amide groups, and acid chlorides. The preferred monomers to be grafted onto the block copolymers are maleic anhydride, maleic acid, fumaric acid, and their derivatives. A further description of functionalizing such block copolymers can be found in U.S. Pat. No. 4,578,429 and U.S. Pat. No. 5,506,299. In another manner, the copolymers employed in the present invention may be functionalized by grafting silicon or boron-containing compounds to the polymer as taught, for example, in U.S. Pat. No. 4,882,384. In still another manner, the block copolymers of the present invention may be contacted with an alkoxy-silane compound to form silane-modified block copolymer. In yet another manner, the block copolymers of the present invention may be functionalized by reacting at least one ethylene oxide molecule to the polymer as taught in U.S. Pat. No. 4,898,914, or by reacting the polymer with carbon dioxide as taught in U.S. Pat. No. 4,970,265. Still further, the block copolymers of the present invention may be metallated as taught in U.S. Pat. No. 5,206,300 and U.S. Pat. No. 5,276,101, wherein the polymer is contacted with an alkali metal alkyl, such as a lithium alkyl. And still further, the block copolymers of the present invention may be functionalized by grafting sulfonic groups to the polymer as taught in U.S. Pat. No. 5,516,831.

It should be noted that the above-described unsaturated block copolymers used to prepare the films of the present invention may, if desired, be readily prepared by the methods set forth above. However, since many such copolymers are commercially available, it is usually preferred to employ the commercially available polymer as this serves to reduce the number of processing steps involved in the overall process. Examples of the above block copolymers which are commercially available include, but are not limited to, KRATON® MD 6459 (commercially available from KRATON Polymers LLC).

The block copolymer layer of the flexible packaging laminate film of the present invention may be modified further with the addition of other polymers, fillers, reinforcements, antioxidants, stabilizers, fire retardants, anti blocking agents, anti-foggers, pigments, slip agents, nucleating agents, nanocomposites, functionalizing agent, suntan screens, lubricants and other rubber and plastic compounding ingredients without departing from the scope of this invention. Such components are disclosed in various patents including, for example, U.S. Pat. No. 3,239,478 and U.S. Pat. No. 5,777,043, the disclosures of which are incorporated by reference. When one or more of such other components are present in the block copolymer layer of the films of the present invention, they will be present in a total amount from about 0.05 weight percent to about 2.0 weight percent based on the total weight percent of the combined components in the block copolymer layer of the film.

As previously noted, the flexible packaging laminate films of the present invention comprise two separate embodiments. The first of these embodiments comprises a flexible packaging laminate film with any number of layers (e.g., from 2 to 15 layers) in which at least one of the outer layers is an unsaturated block copolymer layer. More specifically, the laminate film of this embodiment comprises at least one layer of a polyolefin film bonded together with at least one layer of a block copolymer film wherein at least one of the outer layers is an unsaturated block copolymer layer. One preferred laminate film of this embodiment comprises the structure C-D wherein C is a polyolefin layer and D is a block copolymer layer. Such laminates may be provided by casting the two layers or, alternatively, by blowing said film through a two-annular orifice die. In addition to these two-ply laminates, the present invention also contemplates other multilayered laminates including, but are not limited to, laminates represented by the type C-C-D, C-E-D, D-C-D, D-D-C, C-D-C-D, C-D-E-D, D-C-C-D, D-C-E-D, D-D-C-C, D-D-C-E, D-C-D-C-D, D-C-E-C-D, C-D-C-D-C-D, C-D-E-D-C-D, C-D-E-D-C-D-E-D, C-D-E-D-C-D-E-D, and wherein C is a polyolefin layer, D is a block copolymer layer and E is a polyolefin layer wherein the polyolefin differs from the polyolefin in C. Said additional films may also be prepared by casting the layers or alternatively by blowing said films through a multi-annular, orifice die using any of the processes known in the art for preparing laminate films.

In the second embodiment of the present invention, at least two layers of polyolefin are tied together by at least one layer of a block copolymer. In other words, block copolymer layers are used to tie together polyolefin layers. Within the second embodiment, the multilayer laminates of the present invention can also have any number of layers (e.g., from 3 to 15). One preferred laminate film comprises a three-ply laminate of two polyolefin film layers sandwiching a layer of a block copolymer. That is, the present embodiment contemplates laminates of the structure C-D-C or C-D-E, wherein each C is the same polyolefin, E is a polyolefin that differs from C, and D refers to a layer of block copolymer of the present invention. The three-ply laminates may be provided by casting the three layers or, alternatively, by blowing said film through a three-annular orifice die. In addition to three-ply laminates, the present invention also contemplates other multilayered laminates including , but are not limited to, laminates represented by the type C-D-C, C-D-E, C-D-C-D-C, C-D-C-D-C-D-C, C-D-C-D-C-D-C-D-C, C-D-C-D-C-D-C-D-C-D-C-D-C, C-D-C-D-C-D-C-D-C-D-C-D-C-D-C, C-D-E-D-C, C-D-E-D-C-D-E-D-C, C-D-E-D-C-D-E-D-C-D-E-D-C, C-D-D-E, C-D-D-C, C-C-D-C-C, and C-E-D-E-C, wherein C, D and E are as defined hereinbefore. Said films may be prepared by casting the layers or alternatively by blowing said films through a multi-annular, orifice die using any of the processes known in the art for preparing laminate films.

With regard to the cast or blown film laminates, these laminates have improved interlayer adhesion, improved toughness properties, e.g., improved instrumental impact strength, puncture resistant and improved dart impart strength, as well as improved optical properties. Of particular importance, these laminates provide excellent resistance to delamination. With regard to the laminated films, the block copolymer layers typically constitute from about 10 to about 90% by weight of the laminate film, preferably from about 20% to about 60% by weight of the laminate film and even more preferably from about 25 to about 50% by weight of the laminate film, based on the total weight of the laminate film. The polyolefin film layers typically constitute from about 90% to about 10% by weight of the laminate films, preferably from about 80% to about 40% by weight of the laminate film, and even more preferably from about 75 to about 50% by weight of the laminate film, based on the total weight of the laminate film. One embodiment of the present invention comprises a two-ply laminate (encompassing one polyolefin film layer and one film layer of a block copolymer) wherein the concentration of block copolymer for the laminate typically constitutes from about 40% to about 60% by weight, based on the total weight of the laminate film. The polyolefin film layer typically constitutes from about 60% to about 40%, wherein said percentages are by weight, based on the total weight of the laminate film. An additional embodiment of the present invention comprises a three-ply laminate (encompassing a first outer film layer of polyolefin, a second inner film layer of the same or a different polyolefin and a third outer film layer of block copolymer) wherein the concentration of block copolymer outer film layer typically constitutes from about 10% to about 60% by weight, based on the total weight of the laminate film. The polyolefin film layers constitute from about 90% to about 40%, wherein said percentages are by weight, based on the total weight of the laminate film. Still another embodiment of the present invention comprises a three-ply laminate (encompassing a pair of polyolefin film layers sandwiching a single film layer of a block copolymer) wherein the concentration of block copolymer middle film layer typically constitutes from about 10% to about 60% by weight, based on the total weight of the laminate film. The outer polyolefin film layers constitute from about 90% to about 40%, wherein said percentages are by weight, based on the total weight of the laminate film.

The films of the present invention can be made into articles that can be used in a variety of manners. Such articles include but are not limited to medical packaging (sterile and non-sterile) such as blood bags, IV bags, packages for holding medical equipment/tools/instruments; food wrap and packaging such as bags for holding foodstuffs (sealed and non-sealed) and wraps for containing foods such as used in the food industry and in individual homes; packaging or wraps for typical industrial and houseware applications; and barrier sheets such as one of the layers in a bed coverings, for covering soil beds, skin barrier sheets for stomas, draining wound and other areas subject to irritation.

While not a laminated film, it is also possible to make flexible packaging films from a blend of the polyolefin(s) and block copolymer(s) disclosed herein. In such films at least one block copolymer, as defined hereinbefore, could be blended, using techniques well known in the art, with at least one polyolefin to provide a film. For instance, one or more block copolymers may be physically blended with polypropylene, polyethylene or mixtures of polypropylene and polyethylene. The block copolymer and polyolefin can be simply dry blended without the necessity of any extraordinary measures to combine the two polymers thereby forming a compatible homogeneous film after extrusion

In such films the concentrations of the polyolefin(s) and the block copolymer(s) are such that the polyolefin(s) comprise from about 50% to about 90% and the block copolymer comprises from about 50% to about 10%, said percentages being by weight, based on the total dry blend weight of the polymers. The blend of polyolefin(s) and block copolymer(s) could be processed into a flexible packaging film. More specifically, the film can be prepared as a blown film insofar as blown films provide biaxial orientation. Alternatively, the film may be formed into a cast film by extrusion. With regard to the blown films, it has been advantageously discovered that the blend produces films of reduced gauge insofar as the combination provides higher blowup ratios than could be provided by the polyolefin film itself. This is believed due to the enhanced melt strength provided by the block copolymer. The ability to provide high blowup ratios results, as those skilled in the art are aware, in thinner gauge films, which is highly desirable in the flexible packaging film industry. Thinner gauge films provide the same functionality as thicker gauge films but at significantly reduced material cost. In addition, thin gauge films produced by the blown film method have superior optical qualities, e.g., optical. Such optical qualities are also seen in cast films. Improved toughness, as manifested by dart impact and puncture resistance, is also a characteristic of the films formed of a mono polyolefin-block copolymer blend.

The following examples are given to illustrate the present invention. These examples are given for illustrative purposes only, and should not be construed as limiting the present invention.

### EXAMPLES

The following components are used in the Examples that follow:

BCP1 (Block Copolymer 1) is an unsaturated block copolymer having a modulus of about 73,000 and a polystyrene content of about 75% by weight, a melt flow index of 11 g/10 min @ 200° C./5 kg, commercially available from KRATON Polymers LLC as KRATON® MD6459.

LDPE 1 (Marflex® 5355) is a low density polyethylene that is commercially available from Chevron Phillips having a MFI=2 g/10 min @ 190C/2.16 kg, and a density=0.927 g/cm³

LDPE 2 (LDPE 1010®) is a low density polyethylene polymer supplied by Huntsman Polymers.

LDPE 3 (PE 5050®) is a low density polyethylene polymer supplied by Huntsman Polymers.

LLDPE 1 (Marflex R-7109M) is a linear, low density polyethylene that is commercially available from Chevron Phillips having a MFI=0.9 g/10 min @ 190C/2.16 kg and a density=0.918 g/cm³

LLDPE 2 (LLDPE 8101®) is a linear, low density polyethylene polymer supplied by Huntsman Polymers.

PP 1 (Sunoco FT021N) is a homopolymer polypropylene (PP) commercially available from Sunoco having a MFI=2.6g/10 min @ 230C/2.16 kg.

PP 2 (12N25A®) is a polypropylene polymer supplied by Huntsman Polymers.

PP3 12G25A® is a polypropylene polymer supplied by Huntsman Polymers.

PS (EA3300) is a polystyrene commercially available from Chevron Phillips having a MFI=1.8g/10 min @ 200C/5 kg

D1403 (KRATON® D1403) is an SBS block copolymer commercially available from KRATON Polymers LLC having a MFI=1 lg/10min @ 200C/5kg

3G55 is an SBS block copolymer commercially available from BASF having a MFI=14.5g/10min @ 200C/5kg

The amounts below are in weight percentages unless otherwise specified. The test methods used in the Examples are American Society for Testing Materials (ASTM) test methods, unless otherwise specified. The specific methods are set forth in Table 1:

TABLE 1
ASTM Test Methods

| TEST | ASTM No. |
|---|---|
| Light Transmittance | D-1003 |
| Haze | D-1003 |
| Gloss In | D-2457 |
| Gloss Out | D-2457 |
| Coefficient of Friction (COF) In/Out | D-1894 |
| Eval. Gauge | Manual measurement- via caliper |
| Tensile Properties for Tables 4 and 7 | D-882 |
| Tensile Properties for Table 8 | D-638 |
| Elmendorf Tear | D-1922 |
| Dart Impact | D-1709 |
| T Peel Test | D-1876-61T |
| Instrumented Impact | D-3763 |

For the examples noted below, a series of three-layered films were prepared in which various polyolefins, including low density polyethylene (LDPE), linear low density polyethylene (LLDPE) and polypropylene (PP), were used with layers of the block copolymers of the present invention to produce laminated packaging films. More specifically, BCP1, within the present invention, was utilized in preparing the laminates, which were thereafter tested to determine their feasibility for use as packaging films.

In Examples 1 to 6, the laminates were prepared by casting and co-extruding each of the layers of the films utilizing a Killion coextrusion machine under the following parameters

Killion Multilayer Film Line

| Film Skin Layers | LDPE 1 | | LLDPE 1 | | PP 1 | |
|---|---|---|---|---|---|---|
| Extruder Temperature | 188-204° | C. | 188-204° | C. | 199-216° | C. |
| Range | | | | | | |
| Die Temperature | 200° | C. | 200° | C. | 210-217° | C. |
| Chill Roll Temperature | 17° | C. | 17° | C. | 17° | C. |

Once the films were extruded, they were placed at a constant temperature and humidity (23° C., 50% humidity) for at least 48 hours before testing.

The actual films made included outer layers of the noted polyolefin and an inner layer of the block copolymer of the present invention (BCP1) or a polymer of the prior art (e.g., PS, D1403, or 3G55). For example, films of the structure C-D-C were made wherein C is a polyolefin layer and D is a styrenic block copolymer layer either of the present invention or of the prior art. Also included for comparative purposes were control laminated films that consisted of polyolefin layers only (i.e., three layers of LDPE, LLDPE or PP). The controls were made in the same manner as the other films with the exception that each layer comprised the same material. For example, films of the structure C-C-C were made wherein each C is a polyolefin layer. In addition, films having different gauges were also tested.

Note that the haze properties were measured on BYK Gardner Haze-gard Plus. Impact properties were measured using a Dynatup Impact Tester. Film Impact Method: 6,959 lb hammer wt. 500 lb Piezo tup. 22.75″ gravity drop. The impact speed was at 3600 in/min.

### Example 1

A series of films were prepared in the manner noted above. These films were then subjected to T Peel test to determine the degree of adhesion between the layers. The results are in Table 2 below.

TABLE 2
Adhesion Between LDPE, LLDPE, and Homo-PP
Skin Using SBC Layers as the Tie Layer
(films of a 4 mil gauge with the mid layer comprising 2 mil)

| | Structure | |
|---|---|---|
| Example # | Layer C/Layer D/Layer C | T Peel (pli) |
| C. Ex. 1 | LDPE 1/PS/LDPE 1 | 0.07 |
| C. Ex. 2 | LDPE 1/D1403/LDPE 1 | 0.25 |
| C. Ex. 3 | LDPE 1/3G55/LDPE 1 | 0.15 |
| Ex. 1 | LDPE 1/BCP1/LDPE 1 | No delamination, LDPE |
| | | stretched |
| C. Ex. 4 | LLDPE 1/PS/LLDPE 1 | 0.21 |
| C. Ex. 5 | LLDPE 1/D1403/LLDPE 1 | 1.67 |
| C. Ex. 6 | LLDPE 1/3G55/LLDPE 1 | 1.41 |
| Ex. 2 | LLDPE 1/BCP1/LLDPE 1 | No delamination, LLDPE |
| | | stretched |
| C. Ex. 7 | PP 1/PS/PP 1 | 0 |
| C. Ex. 8 | PP 1/D1403/PP 1 | 0.14 |
| Ex. 3 | PP 1/BCP1/PP 1 | 0.52 |

With regard to the data in Table 2 above, it can be seen that when polystyrene (PS) was used as the tie layer for two layers of LDPE (C. Ex. 1), adhesion was poor. The same was found when PS was used as the tie layer for LLDPE (C. Ex. 4) and Homo PP (C. Ex. 7). While differing levels of adhesion were observed for the styrenic block copolymers with regard to different polyolefins, in all cases, BCP1 had significantly higher interlayer adhesion than the other styrenic polymers.

### Example 2

Additional three layer laminated films of the present invention were made and compared to laminated films made with different polymers as the tie layer. The films were then subjected to haze and impact tests as defined hereinbefore. The results are listed in Table 3 below.

TABLE 3
Haze and Impact Properties of Three Layer Coextruded
Films Having LDPE Outer Layers

| | | | | Instrumented |
|---|---|---|---|---|
| | | Gauge | Haze, | impact, |
| Example | Structure | mil | % | total energy, in-lb |
| C. Ex. 1 | LDPE 1/LDPE 1/LDPE 1 | 1/2/1 | 6.2 | 3.0 |
| C. Ex. 2 | LDPE 1/PS/LDPE 1 | 1/2/1 | 4.5 | 0.4 |
| C. Ex. 3 | LDPE 1/D1403/LDPE 1 | 1/2/1 | 3.6 | 6.5 |
| C. Ex. 4 | LDPE 1/3G55/LDPE 1 | 1/2/1 | 3.6 | 5.3 |
| Ex. 1 | LDPE 1/BCP1/LDPE 1 | 1/2/1 | 3.9 | 5.1 |
| C. Ex. 5 | LDPE 1/D1403/LDPE 1 | 1/1/1 | 4.3 | 3.0 |
| Ex. 2 | LDPE 1/BCP1/LDPE 1 | 1/1/1 | n.a. | 2.6 |

With regard to the data in Table 3, haze was reduced and impact increased when styrenic block copolymers were used as tie layers for LDPE compared to films in which the LDPE layers were tied using PS or another LDPE layer. As can be seen from this data, the haze and impact properties for BCP 1 were found to be comparable to those of D1403 and 3G55. Accordingly, Applicants have achieved a laminated film in which interlayer adhesion is increased without adversely affecting haze and impact.

### Example 3

Additional three layer laminated films of the present invention were made and compared to laminated films made with different polymers as the tie layer. The films were then subjected to tensile strength, tensile elongation and tearing force tests. The results are in Table 4 below.

TABLE 4
Tensile and Tear Properties of Three Layer Co-Extruded Films
Having LDPE Outer Layers

| | | | Tensile | Tensile | Tearing |
|---|---|---|---|---|---|
| | | Gauge, | Strength | Elongation | Force |
| | Structure | Mil | psi | % | gf |
| C. Ex. 1 | LDPE 1/LDPE | 1/2/1 | 3216 | 575 | 509 |
| | 1/LDPE 1, MD | | | | |
| C. Ex. 1 | LDPE 1/LDPE | 1/2/1 | 2348 | 781 | 918 |
| | 1/LDPE 1, TD | | | | |
| C. Ex. 2 | LDPE 1/PS/ | 1/2/1 | 5599 | 5 | 92 |
| | LDPE 1, MD | | | | |
| C. Ex. 2 | LDPE 1/PS/ | 1/2/1 | 1794 | 2 | 132 |
| | LDPE 1, TD | | | | |
| C. Ex. 3 | LDPE 1/D1403/ | 1/2/1 | 4195 | 443 | 79 |
| | LDPE 1, MD | | | | |
| C. Ex. 3 | LDPE 1/D1403/ | 1/2/1 | 3322 | 460 | 159 |
| | LDPE 1, TD | | | | |
| C. Ex. 4 | LDPE 1/3G55/ | 1/2/1 | 4268 | 532 | 145 |
| | LDPE 1, MD | | | | |
| C. Ex. 4 | LDPE 1/3G55/ | 1/2/1 | 3397 | 571 | 452 |
| | LDPE 1, TD | | | | |
| Ex. 1 | LDPE 1/BCP1/ | 1/2/1 | 4363 | 562 | 159 |
| | LDPE 1, MD | | | | |
| Ex. 1 | LDPE 1/BCP1/ | 1/2/1 | 3799 | 582 | 748 |
| | LDPE 1, TD | | | | |
| C. Ex. 5 | LDPE 1/D1403/ | 1/1/1 | 4205 | 461 | 40 |
| | LDPE 1, MD | | | | |
| C. Ex. 5 | LDPE 1/D1403/ | 1/1/1 | 2764 | 520 | 310 |
| | LDPE 1, TD | | | | |
| Ex. 2 | LDPE 1/BCP1/ | 1/1/1 | 4398 | 551 | 86 |
| | LDPE 1, MD | | | | |
| Ex. 2 | LDPE 1/BCP1/ | 1/1/1 | 2879 | 577 | 661 |
| | LDPE 1, TD | | | | |

When styrenic block copolymers were used as the tie layer (mid-layer) for LDPE, higher tensile strength was observed compared to the LDPE multilayer control. In addition, higher tensile elongation was observed when styrenic block copolymers were used compared to when PS was used as the tie layer. As can be seen from this data, the tensile strength and elongation properties for BCP 1 were found to be comparable to those of D1403 and 3G55. Accordingly, Applicants have achieved a laminated film in which interlayer adhesion is increased without adversely diminishing tensile properties.

### Example 4

Additional three layer laminated films of the present invention were made and compared to laminated films made with different polymers as the tie layer. The films were then subjected to haze and impact tests as defined hereinbefore. The results are in Table 5 below.

TABLE 5
Haze and Impact Properties of Three Layer Co-Extruded
Films Having LLDPE Outer Layers

| | | | | Instrumented |
|---|---|---|---|---|
| | | Gauge | Haze, | impact, |
| | Structure | mil | % | total energy, |
| C. Ex. 1 | LLDPE 1/LLDPE 1/LLDPE 1 | 1/2/1 | 14.2 | 2.9 |
| C. Ex. 2 | LLDPE 1/PS/LLDPE 1 | 1/2/1 | 24.4 | 1.0 |
| C. Ex. 3 | LLDPE 1/D1403/LLDPE1 | 1/2/1 | 8.5 | 5.4 |
| C. Ex. 4 | LLDPE 1/3G55/LLDPE1 | 1/2/1 | 8.9 | 4.8 |
| Ex. 1 | LLDPE 1/BCP1/LLDPE1 | 1/2/1 | 9.0 | 4.6 |
| C. Ex. 5 | LLDPE 1/D1403/LLDPE1 | 1/1/1 | 10.4 | 3.3 |
| C. Ex. 6 | LLDPE 1/3G55/LLDPE1 | 1/1/1 | 9.1 | 3.0 |
| Ex. 2 | LLDPE1/BCP1/LLDPE1 | 1/1/1 | 9.1 | 2.6 |

With regard to the data in Table 5, haze was reduced and impact increased when styrenic block copolymers were used as tie layers for LLDPE compared to films in which the LDPE layers were tied using PS or another LLDPE layer. As can be seen from this data, the haze and impact properties for BCP 1 were found to be comparable to those of D1403 and 3G55. Accordingly, Applicants have achieved a laminated film in which adhesion is increased without adversely affecting haze and impact.

### Example 5

Additional three layer laminated films of the present invention were made and compared to laminated films made with different polymers as the tie layer. The films were then subjected to haze and impact tests as defined hereinbefore. The results are in Table 6 below.

TABLE 6
Three Layer Co-Extruded Films Using PP
Homopolymer as the Outer Layers

| | | Gauge, | | Instrumented impact, |
|---|---|---|---|---|
| | Structure | mil | Haze, % | total energy, in-lb |
| C. Ex. 1 | PP 1/PP 1/PP 1 | 1/2/1 | 7.6 | 0.9 |
| C. Ex. 2 | PP 1/PS/PP1 | 1/2/1 | 6.8 | 0.4 |
| C. Ex. 3 | PP 1/D1403/PP1 | 1/2/1 | 6.9 | 1.7 |
| Ex. 1 | PP 1/BCP1/PP1 | 1/2/1 | 6.1 | 5.5 |

With regard to the data in Table 6, haze was reduced and impact increased when styrenic block copolymers were used as tie layers for LDPE compared to films in which the layers were all PP. In addition, impact increased when styrenic block copolymer were used compared to films in which the tie layer was PS. As can be seen from this data, the haze and impact properties for BCP 1 were found to be better to those of D1403. Accordingly, Applicants have achieved a laminated film in which adhesion is increased without adversely increasing haze or decreasing impact.

### Example 6

Additional three layer laminated films of the present invention were made and compared to laminated films made with different polymers as the tie layer. The films were then subjected to tensile strength, tensile elongation and tearing force tests. The results are in Table 7 below. Films were tested using ASTM D882 Sheet Tensile method.

TABLE 7
Tensile and Tear Properties of Three Layer Co-Extruded Films Having PP
Outer Layers

| | | | | Tensile | |
|---|---|---|---|---|---|
| | | | Tensile | Elonga- | |
| | | Gauge, | Strength | tion | Tearing |
| | Structure | mil | Psi | % | force, gf |
| C. Ex. 1 | PP1/PP1/PP1, MD | 1/2/1 | 6330 | 783 | 48 |
| C. Ex. 1 | PP1/PP1/PP1, TD | 1/2/1 | 4420 | 7 | 141 |
| C. Ex. 2 | PP 1/PS/PP1, MD | 1/2/1 | 6224 | 4 | 32 |
| C. Ex. 2 | PP 1/PS/PP1, TD | 1/2/1 | 2699 | 2 | 99 |
| C. Ex. 3 | PP 1/D1403/PP1, | 1/2/1 | 3858 | 455 | 95 |
| | MD | | | | |
| C. Ex. 3 | PP 1/D1403/PP1, TD | 1/2/1 | 2927 | 167 | 273 |
| Ex. 1 | PP 1/BCP1/PP1, MD | 1/2/1 | 4171 | 488 | 200 |
| Ex. 1 | PP 1/BCP1/PP1, TD | 1/2/1 | 3351 | 549 | 356 |

Using styrenic block copolymers as tie layers results in significantly higher tensile elongation in TD than the two control films with the tensile elongation of BCP1 being the better of the styrenic block copolymers. Using styrenic block copolymers as tie layers results in significantly higher tearing resistance performance in both TD and MD than the two control films with BCP1 again being the better performer of the styrenic block copolymers.

### Example 7

A series of three layer laminated films of the present invention were made and compared to laminated films made with different polymers as the tie layer. The laminates were prepared by casting and coextruding each of the layers. The laminates included outer layers of polyolefin and inner layers of block copolymers. The films were then subjected to tensile strength, tensile elongation and tearing force tests. The results are in Table 8 below. Films were tested using ASTM D638 Tensile method.

Table 8 below includes the various formulations that were used, the processing conditions used in formulating the same, and various physical test results for each of the formulations prepared. The designation A1, A2, A3, etc is used herein to denote repeated testing using the same formulations. The numbers in parentheses show standard deviations for multiple runs. Table 8 below includes various physical test results for each of the samples prepared.

TABLE 8

| | | | | COF, | COF, |
|---|---|---|---|---|---|
| | | Light | | Static | kinetic |
| | Structure | Transmittance | Haze | (In) | (Out) |
| Ex. 1 | PP2/BCP1/PP2 | 94.55 | 4.72 | 0.28 | 0.22 |
| | | (0.07) | (0.17) | | |
| Ex. 2 | PP2/BCP1/LDPE 3 | 93.9 | 2.16 | 0.31 | 0.22 |
| | | (0.07) | (0.42) | | |
| Ex. 3 | PP3/BCP1/PP3 | 94.4 | 6.88 | 0.37 | 0.23 |
| | | (0.07) | (0.11) | | |
| Ex. 4 | PP3/BCP1/LDPE 3 | 94.4 | 6.72 | 0.43 | 0.32 |
| | | (0.07) | (0.08) | | |

| | | Eval. | | | | |
|---|---|---|---|---|---|---|
| | | Gauge, | | | Tensile | |
| | | mil total | Tensile @ | Elongation @ | Modulus, | Elmendorf |
| MD | Structure | (M_{D}) | Brk, psi | Brk, % | psi | Tear, g |
| Ex. 1 | PP2/BCP1/PP2 | 2 | 3,430 | 519 | 62,063 | 205 |
| Ex. 2 | PP2/BCP1/PE | 2 | 2,870 | 426 | 64,817 | 195 |
| Ex. 3 | PP3/BCP1/PP3 | 3 | 2,533 | 514 | 36,481 | 448 |
| Ex. 4 | PP3/BCP1/LDPE 3 | 3 | 2,073 | 441 | 31,130 | 170 |

| | | Eval. | | | | | |
|---|---|---|---|---|---|---|---|
| | | Gauge, | Tensile @ | | Tensile | | |
| | | mil total | Brk, | Elongation @ | Modulus, | Elmendorf | |
| TD | Structure | (M_{P}) | psi | Brk, % | psi | Tear, g | Dart, g |
| Ex. 1 | PP2/BCP1/PP2 | 2 | 3,000 | 583 | 37,037 | 189 | 160 |
| Ex. 2 | PP2/BCP1/PE | 2 | 2,340 | 542 | 45,337 | 253 | 305 |
| Ex. 3 | PP3/BCP1/PP3 | 3 | 1,987 | 616 | 24,317 | 256 | 298 |
| Ex. 4 | PP3/BCP1/LDPE 3 | 3 | 1,667 | 517 | 19,969 | 381 | 621 |

In general, Examples 1, 2, 3 and 4, given the gauge, the PE or PP or PP/PE combination used, and at different concentrations of block copolymer in the core, have superior dart and tear properties. All samples have superior elongation and optical properties. Furthermore, the adhesion to both types of polyolefins was strong, and the results were superior.

The data provided above indicate the expected physical/mechanical properties that can be achieved by combining a block copolymer layer such as BCP1 with polyolefin layers in laminated films. In the past, this has not been possible unless a material with a functionality (a tie layer), or a special blend of multiple components was utilized to compensate for the lack of affinity that polyolefins have with respect to styrene-containing products.

Again, the key to the inventive laminates is the specific styrenic block copolymers that demonstrate a strong affinity to polyolefins, and are capable of being processed in a conventional extrusion line, also with down-gauging potential.

The above embodiments and examples are given to illustrate the scope and spirit of the present invention. These embodiments and examples will make apparent, to those skilled in the art, other embodiments and examples. Those other embodiments and examples are within the contemplation of the present invention. Therefore, the present invention should be limited only by appended claims.

What is claimed is:

1. A flexible packaging laminate film having improved interlayer adhesion properties comprising at least one layer of a polyolefin and at least one layer of an unhydrogenated block copolymer, wherein
(1) said block copolymer has a monoalkenyl arene content equal to or greater than 60 weight percent;
(2) said block copolymer has a modulus less than 100,000; and
(3) said block copolymer comprises at least two A blocks and at least one B block, each A block is independently selected from mono alkenyl arene polymer blocks and each B block is independently selected from
(a) polymer blocks having at least one conjugated diene and at least one mono alkenyl arene and having a random distribution;
(b) polymer blocks having at least one conjugated diene and at least one mono alkenyl arene and having a blocked distribution;
(c) polymer blocks having at least one conjugated diene and at least one mono alkenyl arene and having a tapered distribution; and
(d) polymer blocks having at least one conjugated diene and at least one mono alkenyl arene and having a controlled distribution.

2. The flexible packaging laminate film of claim 1 wherein said laminate film comprises at least two layers of a polyolefin and at least one layer of an unhydrogenated block copolymer.

3. The flexible packaging laminate film of claim 2 wherein said laminate film comprises a layer of said block copolymer sandwiched between the layers of said polyolefin.

4. The flexible packaging laminate film of claim 3 wherein said first and second layers of said polyolefin component are the same polyolefin.

5. The flexible packaging laminate film of claim 3 wherein said first and second layers of said polyolefin are different polyolefins.

6. The flexible packaging laminate film of claim 2 wherein said polyolefin comprises low density polyethylene (LDPE), high density polyethylene (HDPE), linear low density polyethylene (LLDPE), ultra low density polyethylene (ULDPE), very low density polyethylene (VLDPE), medium density polyethylene (MDPE), polypropylene (PP), copolymers of ethylene and vinyl alcohol, or a copolymer of ethylene and vinyl acetate.

7. The flexible packaging laminate film of claim 3 wherein said polyolefin comprises low density polyethylene (LDPE), high density polyethylene (HDPE), linear low density polyethylene (LLDPE), ultra low density polyethylene (ULDPE), very low density polyethylene (VLDPE), medium density polyethylene (MDPE), polypropylene (PP), copolymers of ethylene and vinyl alcohol, or a copolymer of ethylene and vinyl acetate.

8. The flexible packaging laminate film of claim 6 wherein said polyolefin is present in a concentration from 10% to 90% and said styrenic block copolymer is present in a concentration from 90% to 10%, said percentages being by weight, based on the total weight of said packaging film.

9. The flexible packaging laminate film of claim 2 wherein said polyolefin is present in a concentration from 10% to 90% and said styrenic block copolymer is present in a concentration from 90% to 10%, said percentages being by weight, based on the total weight of said packaging film.

10. The flexible packaging laminate film of claim 2 wherein in each B block, the mono alkenyl arene comprises styrene and the conjugated diene comprises butadiene or isoprene or mixtures thereof.

11. The flexible packaging laminate film of claim 10 wherein each B block has a random distribution.

12. The flexible packaging laminate film of claim 10 wherein each B block has a blocked distribution.

13. The flexible packaging laminate film of claim 10 wherein each B block has a tapered distribution.

14. The flexible packaging laminate film of claim 10 wherein each B block has a controlled distribution.

15. The flexible packaging laminate film of claim 2 wherein said polyolefin and said block copolymer comprises a laminate having from 3 to 15 layers.

16. A flexible packaging laminate film having improved interlayer adhesion properties comprising at least two layers of a polyolefin and at least one layer of an unhydrogenated block copolymer, wherein
(1) said block copolymer has a monoalkenyl arene content equal to or greater than 60 weight percent; and
(2) said block copolymer has a modulus less than 100,000,
(3) said block copolymer comprises at least two A blocks and at least one B block, each A block is independently selected from mono alkenyl arene polymer blocks and each B block is independently selected from
(a) polymer blocks having at least one conjugated diene and at least one mono alkenyl arene and having a random distribution;
(b) polymer blocks having at least one conjugated diene and at least one mono alkenyl arene and having a blocked distribution;
(c) polymer blocks having at least one conjugated diene and at least one mono alkenyl arene and having a tapered distribution; and
(d) polymer blocks having at least one conjugated diene and at least one mono alkenyl arene and having a controlled distribution.
(4) said polyolefin comprises low density polyethylene (LDPE), high density polyethylene (HDPE), linear low density polyethylene (LLDPE), ultra low density polyethylene (ULDPE), very low density polyethylene (VLDPE), medium density polyethylene (MDPE), polypropylene (PP), copolymers of ethylene and vinyl alcohol, or a copolymer of ethylene and vinyl acetate; and
(5) in said packaging film, said polyolefin is present in a concentration from 10% to 90% and said styrenic block copolymer is present in a concentration from 10% to 90%, said percentages being by weight, based on the total weight of said packaging film.

17. The flexible packaging laminate film of claim 16 wherein in each B block, the mono alkenyl arene comprises styrene and the conjugated diene comprises butadiene or isoprene or mixtures thereof.

18. The flexible packaging laminate film of claim 17 wherein said laminate film comprises from 3 to 15 layers.

19. The flexible packaging laminate film of claim 17 wherein said laminate film comprises a layer of said block copolymer sandwiched between first and second layers of said polyolefin.

20. The flexible packaging laminate film of claim 19 wherein said first and second layers of said polyolefin component are the same polyolefin.

21. The flexible packaging laminate film of claim 19 wherein said first and second layers of said polyolefin are different polyolefins.

22. An article comprising the flexible packaging laminate film of claim 1.
